(19) United States
(12) Patent Application Publication
(10) Pub. No.: US 2005/0131577 A1
(43) Pub. Date: Jun. 16, 2005

(54) Cashless vending system, method, vending machine, and center apparatus

(75) Inventors: Michihiro Ota, Saitama (JP); Hiroaki Yoshida, Saitama (JP); Hiroaki Shinada, Saitama (JP); Kumiko Hisai, Saitama (JP); Hiroki Hoshino, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KABUSHIKI KAISHA NIPPON CONLUX, Tokyo 100-0011 (JP)

(21) Appl. No.: 10/507,219

(22) PCT Filed: Nov. 14, 2002
(86) PCT No.: PCT/JP02/11867

(30) Foreign Application Priority Data
Mar. 20, 2002 (JP) 2002-79017

(51) Int. Cl. G06F 17/00

(52) U.S. Cl. 700/242

(57) ABSTRACT

A cashless vending system using a portable communication terminal, which can make a conventional vending machine into the cashless type with ease without requiring users to perform a complex operation. When a vending machine 1 detects that a change return lever is operated by a user after a settlement request code is issued, the vending machine 1 issues a settlement cancellation request code requesting the cancellation of a settlement according to the settlement request code, and a center device 3 performs cancel processing of the settlement according to the settlement cancellation request code received from the vending machine 1 via a portable telephone terminal 2.

### TECHNICAL FIELD

The present invention relates to a cashless vending system and method, a vending machine and a center device, and more particularly to a cashless vending system and method, a vending machine and a center device, which settle sales of the vended commodities and services by means of portable communication terminals possessed by users.

### BACKGROUND ART

A user inserts a value such as money or a prepaid card into each of many vending machines being used at present to buy a desired commodity or service.

To use such a vending machine, the user must always have cash or a card. Especially, it is inconvenient to have many prepaid cards for individual systems in order to obtain various kinds of services. Meanwhile, a seller loses the opportunity of sales because of a shortage in change or the like, and a card-usable vending machine must be provided with a card reader/writer and many cards must be issued, involving enormous time and costs.

Small and highly functional portable communication terminals such as cellular phones and PHSs are becoming increasing common in these years, and there are proposed cashless systems using such communication terminals for vending machines.

But, the above conventional cashless systems using the portable communication terminals require users to make a troublesome operation for personal verification and the like, and the users cannot buy commodities easily. And, the seller side incurs enormous costs because it is necessary to connect the vending machines online. Besides, the existing vending machines have disadvantages that the above-described system cannot be provided and its widespread use is not easy.

Therefore, the present inventor has proposed a cashless vending system in Japanese Patent Application No. 2001-362973 that a settlement request code to request settlement for a commodity selected is issued from a vending machine, a center device performs a settlement processing according to the settlement request code received from the vending machine via a user's portable telephone terminal, performs a prescribed processing of the settlement request code to produce a sales permission code and sends it to the portable telephone terminal, and the vending machine reads the sales permission code displayed on the display of the portable telephone terminal and controls the sales of the commodity according to the sales permission code.

But, the cashless vending system proposed in the above-described Japanese Patent Application No. 2001-362973 receives the settlement request code by the center device and performs the settlement processing, and if normal selling is not performed because of a defect in communications or the like, the settlement processing once performed by the center device cannot be cancelled safely and securely.

### DISCLOSURE OF THE INVENTION

Accordingly, the present invention provides a cashless vending system and method, a vending machine and a center device, which do not require users to perform a complex operation and can cancel a settlement processing safely.

In order to achieve the above object, the cashless vending system of the present invention comprises a vending machine for vending commodities; a portable communication terminal used to purchase commodities from the vending machine; and a center device for managing the sales of the commodities from the vending machine using the portable communication terminal, wherein: the vending machine comprises: a first code issuing means for issuing a first code about the sales of a commodity in response to a request by a user who desires to buy the commodity; a second code obtaining means for obtaining a second code about commodity selling permission, which is issued by the center device according to communications with the center device by the portable communication terminal, via the portable communication terminal; a sales control means for controlling the sales of the commodity according to the second code obtained by the second code obtaining means; and a third code issuing means for issuing a third code about cancellation of the sales of the commodity according to an operation by the user; the portable communication terminal comprises: a first input means for inputting the first code which is issued by the first code issuing means of the vending machine; a first transmitting means for sending the first code, which is input by the first input means, to the center device; a receiving means for receiving the second code which is issued by the center device; a second input means for inputting the third code which is issued by the third code issuing means of the vending machine; and a second transmitting means for sending the third code, which is input by the second input means, to the center device; and the center device comprises: a verifying means for verifying the portable communication terminal according to communications with the portable communication terminal; a settlement processing means for performing a settlement processing according to the first code sent by the first transmitting means of the portable communication terminal; a second code issuing means for generating the second code by performing a prescribed processing of the first code and sending to the portable communication terminal; and a settlement processing cancel means for canceling the settlement processing according to the third code sent from the second transmitting means of the portable communication terminal.

Here, the portable communication terminal has a display means for displaying the second code received by the receiving means; the vending machine has an image reading means for reading the second code displayed on the display means; and the second code obtaining means obtains the second code by reading the second code, which is displayed on the display means, by the image reading means.

And, the vending machine has a display for displaying the first code which is issued by the first code issuing means; the portable communication terminal has an imaging means which is built in or externally connected; and the first input means inputs the first code by taking a picture of the first code, which is displayed on the display of the vending machine, by the imaging means.

The vending machine has a change return lever and a detecting means for detecting an operation of the change return lever; and the third code issuing means performs a prescribed processing of the first code to generate the third code and issues it when the operation of the change return lever is detected by the detecting means after the first code is issued by the first code issuing means.

The vending machine has a display for displaying the third code which is issued by the third code issuing means; the portable communication terminal has an imaging means which is built in or externally connected; and the second input means inputs the third code by taking a picture of the third code, which is displayed on the display of the vending machine, by the imaging means.

And, a cashless vending control method according to the present invention, comprises issuing a first code about the sales of a commodity from a vending machine in response to a request by a user; inputting the first code, which is issued from the vending machine, to a portable communication terminal carried by the user; sending the first code, which is input to the portable communication terminal, from the portable communication terminal to a center device; verifying the portable communication terminal by the center device according to communications with the portable communication terminal; performing a settlement processing of the sales of commodity by the center device according to the first code sent from the portable communication terminal; generating a second code about the commodity selling permission by performing a prescribed processing of the first code by the center device and sending it to the portable communication terminal; displaying the second code, which is sent from the center device, on the display section of the portable communication terminal and presenting it to the vending machine; reading the second code, which is displayed on the display section of the portable communication terminal and presented to the vending machine, by the image reading section of the vending machine; controlling the sales of commodity in the vending machine according to the second code read by the image reading section; issuing a third code about cancellation of the sales of the commodity from the vending machine in response to an operation by the user of the vending machine; sending the third code to the center device when the third code is issued by the third code issuing means of the vending machine; and canceling the settlement processing by the center device according to the third code sent from the portable communication terminal.

Here, the portable communication terminal displays the second code on the display section thereof; and the vending machine obtains the second code by reading the second code displayed on the display section of the portable communication terminal by the image reading means.

The vending machine has a display for displaying the first code; and the portable communication terminal inputs the first code by taking a picture of the first code, which is displayed on the display of the vending machine, by an imaging means which is built in or externally connected to.

The vending machine performs a prescribed processing of the first code to generate the third code and issues it when an operation of a change return lever of the vending machine is detected after the first code is issued.

The vending machine has a display for displaying the third code; and the portable communication terminal inputs the third code by taking a picture of the third code, which is displayed on the display of the vending machine, by an imaging means which is built in or externally connected to.

And, the vending machine of the present invention is a vending machine from which a user can buy commodities by using a portable communication terminal possessed by the user, comprising: a first code issuing means for issuing a first code about the sales of a commodity in response to a request by the user desiring the sales of the commodity; a second code obtaining means for obtaining a second code about commodity selling permission, which is issued by a center device according to communications with the center device by the portable communication terminal, via the portable communication terminal; a sales control means for controlling the sales of the commodity according to the second code obtained by the second code obtaining means; and a third code issuing means for issuing a third code about cancellation of the sales of the commodity according to an operation by the user.

Here, the third code issuing means performs a prescribed processing of the first code to generate the third code and issues it when an operation of a change return lever is detected after the first code is issued by the first code issuing means.

The center device of the present invention is a center device for settling sales made by a vending machine via a portable communication terminal possessed by a user, comprising: a verifying means for verifying the portable communication terminal according to communications with the portable communication terminal; a settlement processing means for performing a settlement processing according to a first code about the sales of a commodity sent from the portable communication terminal; a second code issuing means for generating a second code about commodity selling permission by performing a prescribed processing of the first code and sending it to the portable communication terminal; and a settlement processing cancel means for receiving a third code about the cancellation of the commodity sales issued by the vending machine according to an operation of the vending machine via the portable communication terminal and canceling the settlement processing according to the received third code.

### BRIEF DESCRIPTION OF THE DRAWINGS

FIG. 1 is a block diagram showing an example of a schematic structure of the cashless vending system according to the present invention;

FIG. 2 is a block diagram showing an example of a structure of the vending machine of FIG. 1;

FIG. 3 is a block diagram showing an example of a structure of the center device of FIG. 1;

FIG. 4 is a diagram showing a flow of a commodity sales processing; and

FIG. 5 is a diagram showing a flow of a sales canceling processing.

### BEST MODE FOR CARRYING OUT THE INVENTION

Embodiments of the cashless vending system according to the present invention will be described in detail with reference to the accompanying drawings.

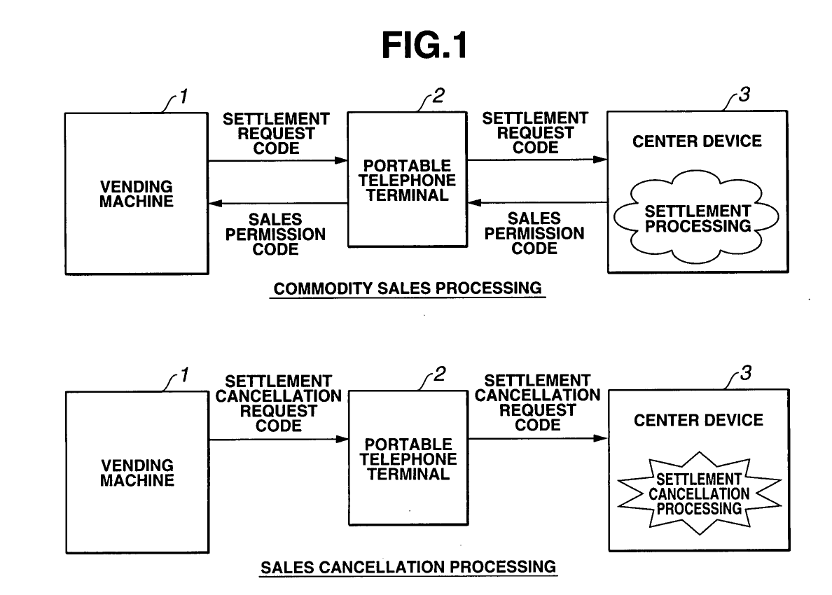

FIG. 1 is a block diagram showing a schematic structure of the cashless vending system according to the present invention.

In FIG. 1, the cashless vending system comprises a vending machine 1 which sells commodities or services, a portable telephone terminal 2 possessed by a user, and a center device 3 which is installed in a company managing the vending machine 1, a company selling as an agency, or the like and connected to a communication network such as the Internet to perform collection of information from the portable telephone terminal 2, storage and management.

The vending machine 1 issues a settlement request code (first code) at the time of selling a commodity. A buyer sends the issued settlement request code to the center device 3 by the buyer's portable telephone terminal 2.

The center device 3 performs a prescribed settlement processing according to the settlement request code sent from the portable telephone terminal 2 and produces a sales permission code (second code) and sends it to the portable telephone terminal 2.

The sales permission code sent from the center device 3 is displayed on the display (not shown) of the portable telephone terminal 2, and the buyer presents the sales permission code displayed on the display (not shown) of the portable telephone terminal 2 to the vending machine 1. The vending machine 1 reads the presented sales permission code and performs a commodity sales processing according to the read sales permission code.

When the sales permission code is not input after the settlement request code is issued and an operation of a change return lever (not shown) is detected, the center device 3 issues a settlement cancellation request code (third code). And, the buyer sends the issued settlement cancellation request code to the center device 3 by the portable telephone terminal 2. The center device 3 performs a settlement cancellation processing to cancel the settlement processing, which is performed based on the corresponding settlement request code, according to the settlement cancellation request code sent from the portable telephone terminal 2.

Here, a structure of the vending machine 1 will be described.

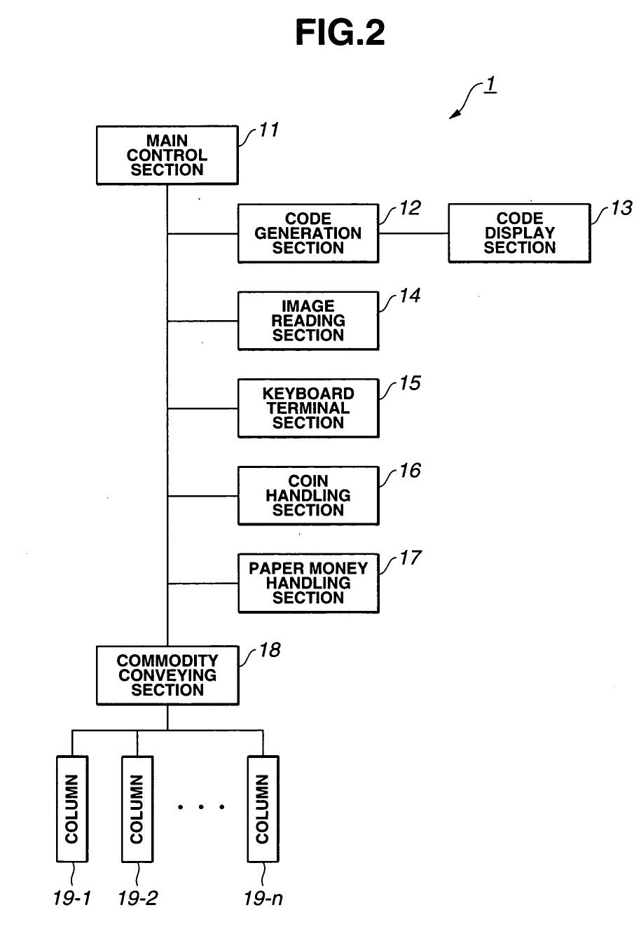

FIG. 2 is a block diagram showing the structure of the vending machine 1.

As shown in FIG. 2, the vending machine 1 comprises a main control section 11, a code generation section 12, a code display section 13, an image reading section 14, a keyboard terminal section 15, a coin handling section 16, a paper money handling section 17, a commodity conveying section 18, and columns 19 (19-1 to 19-n).

The main control section 11 controls the individual sections of the vending machine 1 to control the sales of a commodity and the issue of a settlement request code and a settlement cancellation request code. The code generation section 12 generates the settlement request code and the settlement cancellation request code according to the control signal from the main control section 11. The settlement request code or settlement cancellation request code generated by the code generation section 12 is displayed as visible information (a character string, an image, etc.) by the code display section 13.

The image reading section 14 reads the screen of the portable telephone terminal 2. The keyboard terminal section 15 is used to make various settings such as prices of commodities being sold. The coin handling section 16 receives coins as a price for commodities and returns change, and the paper money handling section 17 processes to receive paper money. The commodity conveying section 18 processes to discharge a commodity according to the control signal from the main control section 11 and controls the discharge of commodities stored in the columns 19. The columns 19 store various kinds of commodities.

The vending machine 1 allows two ways of settlements including a cash settlement and a cashless settlement using the portable telephone terminal 2, and when coins or paper money are put into the vending machine 1 through an unshown coin insertion port or paper money insertion port, the vending machine 1 automatically shifts to a cash settlement mode. When the user operates to request the cashless settlement, the vending machine 1 shifts to the cashless settlement mode.

Here, the operation to request the cashless settlement is, for example, an operation to push a cashless sales button mounted on the vending machine 1.

When it is made possible to allow only the cashless settlement using the portable telephone terminal 2, the coin handling section 16 and the paper money handling section 17 become unnecessary.

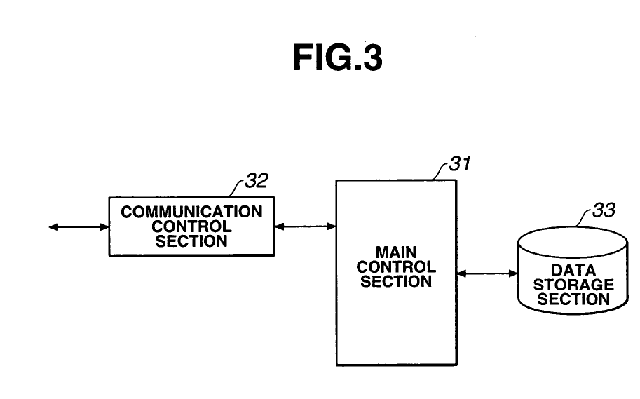

FIG. 3 is a block diagram showing a structure of the center device 3.

As shown in FIG. 3, the center device 3 is comprised of a main control section 31, a communication control section 32 and a data storage section 33.

The main control section 31 controls the individual sections of the center device 3 to perform the settlement processing and the like. The communication control section 32 is connected to a network such as the Internet to control the exchange of data with the portable telephone terminal 2. The data storage section 33 stores various kinds of data necessary for the settlement processing.

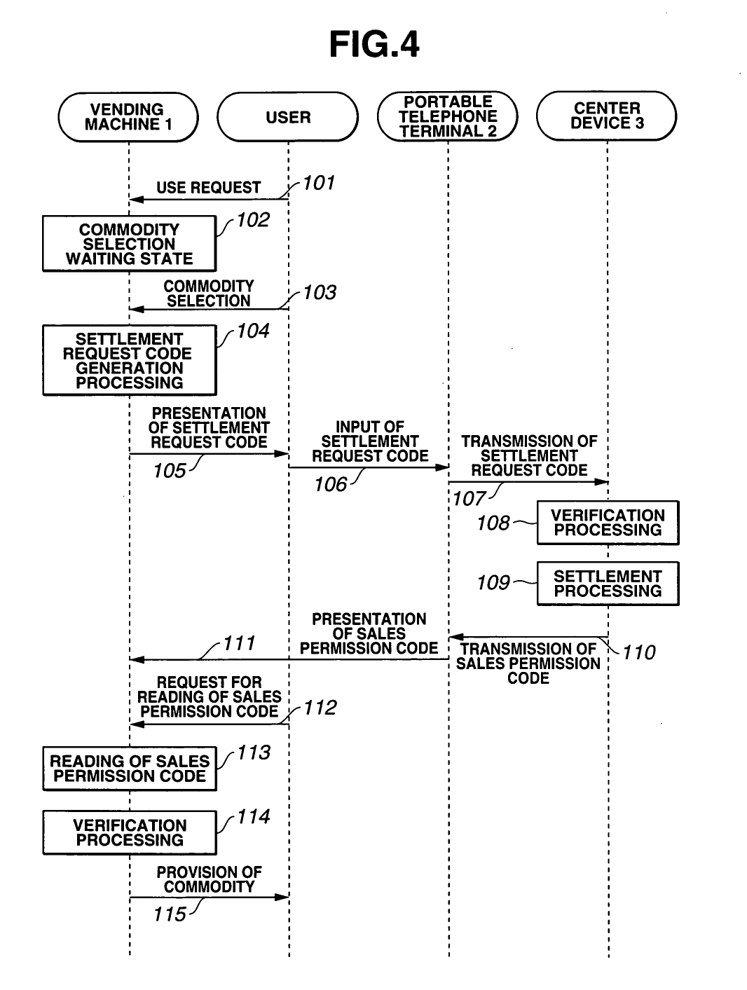

FIG. 4 is a diagram showing a flow of a commodity sales processing according to the cashless settlement mode.

When a user operates the vending machine 1 to request the cashless settlement (step 101), the vending machine 1 falls in a state capable of receiving the selection of a commodity from the user (step 102), the user selects a commodity (step 103), and a settlement request code generation processing is performed (step 104).

Here, the settlement request code contains commodity information such as the type, price and the like of a selected commodity, information inherent to the settlement request code, address information of the center device 3, and the like. Among them, the information inherent to the settlement request code may be formed of, for example, a serial number which is issued every time a commodity is selected or a combination of random numbers and a verification code of the vending machine 1 if the settlement request code can be specified.

The vending machine 1 which has generated the settlement request code visually displays the settlement request code on the display section 13 (step 105). Here, the settlement request code is displayed as a character string comprising figures, characters and marks or image data such as a one-dimensional bar code or a two-dimensional bar code. And, the user inputs the settlement request code displayed on the code display section 13 to the portable telephone terminal 2 (step 106).

Here, the input of the settlement request code to the portable telephone terminal 2 is made via the key input section of the portable telephone terminal 2, or if the portable telephone terminal 2 has a built-in imaging function or can use an imaging attachment, the imaging function can be used to input by picturing the settlement request code displayed on the code display section 13.

When the settlement request code is input, the portable telephone terminal 2 accesses the center device 3 according to the address information of the center device 3 contained in the settlement request code to send the settlement request code (step 107).

Upon receiving the settlement request code, the center device 3 performs first a processing of verifying the portable telephone terminal 2 (step 108). This verification processing is performed according to the information previously registered in the data storage section 33. After verifying the portable telephone terminal 2, the center device 3 performs a settlement processing according to the received settlement request code (step 109).

As a method for the settlement processing, for example, the data storage section 33 stores the amount spent by each user every time the settlement processing is performed, and an actual settlement is made collectively on a prescribed due date. As another method, there can be applied a prepaid method that an amount previously deposited with a management company or the like of the vending machine 1 by the user is stored in the data storage section 33 for each user, and a used amount is charged to the deposited amount every time the settlement processing is made.

In the above-described settlement processing, the center device 3 performs a prescribed processing of the settlement request code sent from the portable telephone terminal 2 to generate the sales permission code and sends it to the portable telephone terminal 2 (step 110). The portable telephone terminal 2 displays the received sales permission code as visible information on an unshown display section.

Here, the sales permission code is shown on the portable telephone terminal 2 as, for example, a character string comprising figures, characters and marks or image data such as a one-dimensional bar code or a two-dimensional bar code.

The user presents the sales permission code displayed on the display section of the portable telephone terminal 2 to the image reading section 14 of the vending machine 1 (step 111) and operates to request reading of the sales permission code (step 112).

Here, the operation to request the reading of the sales permission code is performed by, for example, pushing the image reading button mounted on the vending machine 1.

According to the reading request operation by the user, the vending machine 1 reads the sales permission code displayed on the display section of the portable telephone terminal 2 by the image reading section 14 (step 113) and analyzes the read sales permission code to verify the center device 3 (step 114).

The verification processing of the center device 3 by the vending machine 1 is performed by conducting a prescribed processing of the received sales permission code to reproduce the settlement request code and comparing the reproduced settlement request code and the previously generated settlement request code. If they agree with each other, the vending machine 1 determines the validity of the center device 3, which determines the settlement request code generated by the center device 3 as the sales permission code by the correct processing.

After the verification processing is completed, the vending machine 1 activates the commodity conveying section 18 to provide the user with the commodity (step 115).

It may be configured that, at the time of the verification of the portable telephone terminal 2 in the step 108, the center device 3 requires the user to input a password via the portable telephone terminal 2 to verify the user.

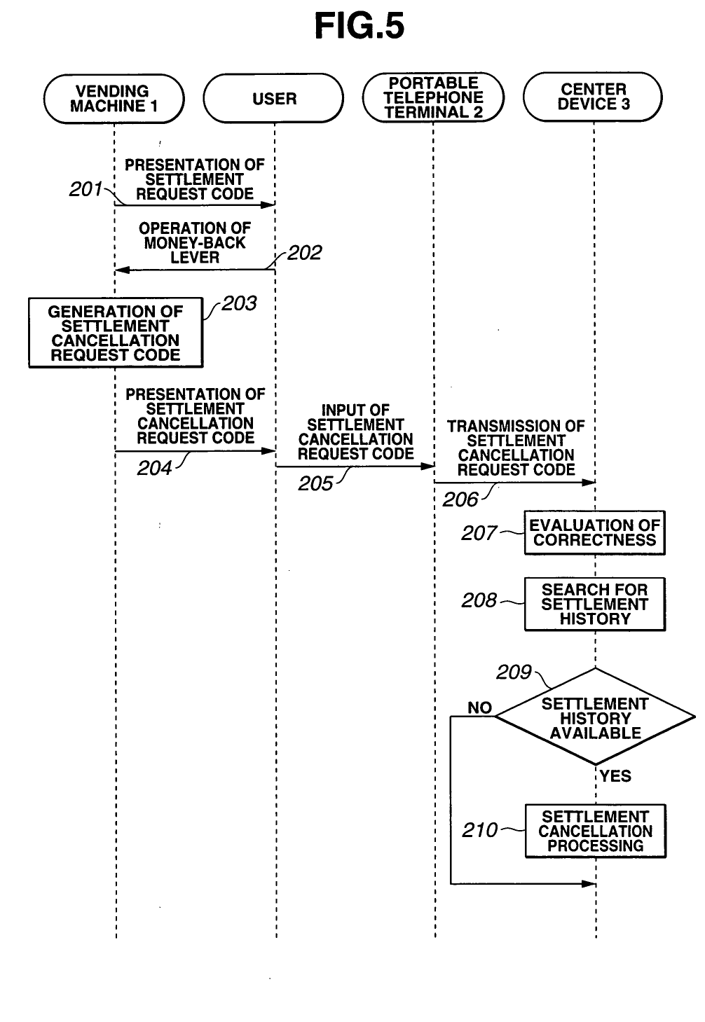

FIG. 5 is a diagram showing a flow of the processing in the cashless settlement mode when the sales permission code is not input after the settlement request code is issued by the vending machine 1 and a change return lever is operated.

After issuing the settlement request code (step 201), when detecting the operation of the change return lever (step 202), the vending machine 1 generates a settlement cancellation request code according to the issued settlement request code (step 203).

Here, the settlement cancellation request code contains specific information for specifying the source settlement request code, date information, address information on the center device 3, and the like.

The vending machine 1 which has generated the settlement cancellation request code visually displays the settlement cancellation request code on the display section 13 (step 204). The settlement cancellation request code is shown as a character string comprising figures, characters and marks or image data such as a one-dimensional bar code or a two-dimensional bar code. And, the user inputs the settlement cancellation request code displayed on the code display section 13 to the portable telephone terminal 2 (step 205).

Here, the settlement cancellation request code can be input to the portable telephone terminal 2 in the same way as the input of the settlement request code.

When the settlement cancellation request code is input, the portable telephone terminal 2 accesses the center device 3 according to the address information on the center device 3 contained in the settlement cancellation request code and sends the settlement cancellation request code (step 206).

The possibility that the buyer operates the change return lever after the settlement request code is issued by the vending machine 1 is:
(1) the buyer changes his/her mind before sending the settlement request code to the center device 3 and cancels the purchase (in this case, the settlement processing was not performed by the center device 3),
(2) the settlement request code is sent to the center device 3 but the sales permission code could not be received by the portable telephone terminal 2 for some reason that communications were defective or the like (in this case, it is not known whether the settlement processing was performed or not by the center device 3), or
(3) the buyer changes his/her mind and cancels the purchase after receiving the sales permission code from the center device 3 (in this case, the settlement processing was performed by the center device 3).

Accordingly, the center device 3 stores a settlement processing history in association with the settlement request code for each user.

Upon receiving the settlement cancellation request code, the center device 3 evaluates correctness of the received settlement cancellation request code by a prescribed method (step 207). If it is correct, the center device 3 specifies the settlement request code, which is the source of the settlement cancellation request code, according to the specific information contained in the settlement cancellation request code and searches for a settlement history corresponding to the settlement request code (step 208). If the corresponding settlement history is not found (NO in step 209), the processing is terminated as it is. Meanwhile, if the corresponding settlement history is found (YES in step 209), this settlement history is cancelled (step 210). The method of canceling the settlement history is performed by, for example, when a settlement method based on the prepaid system that the used amount is deducted at the time of the settlement processing from the total amount previously deposited at the management company or the like of the vending machine 1 is adopted, adding the total amount deducted at the time of the pertinent settlement to the balance.

In the above-described embodiment, the settlement request code and the settlement cancellation request code are issued by the vending machine 1 by displaying on the code display section 13. But, they may be printed out on a prescribed sheet as another method or may be issued by communicating with the portable communication terminal 2 by any of radio communications, infrared communications and voice communications.

### INDUSTRIAL APPLICABILITY

According to the present invention, when a user cancels the purchase of a commodity after the settlement request code (first code) is issued by the vending machine, the vending machine issues a settlement cancellation request code (third code) and sends the settlement cancellation request code to the center device by using the portable communication terminal, and the center device performs the canceling processing of the pertinent settlement according to the settlement cancellation request code. Therefore, the user can cancel easily and securely without executing a complex operation when the user purchases a desired commodity or a desired service from the cashless vending machine via the portable communication terminal.

1. A cashless vending system, comprising:
a vending machine for vending commodities;
a portable communication terminal used to purchase commodities from the vending machine; and
a center device for managing the sales of the commodities from the vending machine using the portable communication terminal, wherein:
the vending machine comprises:
a first code issuing means for issuing a first code about the sales of a commodity in response to a request by a user who desires to buy the commodity;
a second code obtaining means for obtaining a second code about commodity selling permission, which is issued by the center device according to communications with the center device by the portable communication terminal, via the portable communication terminal;
a sales control means for controlling the sales of the commodity according to the second code obtained by the second code obtaining means; and
a third code issuing means for issuing a third code about cancellation of the sales of the commodity according to an operation by the user;
the portable communication terminal comprises:
a first input means for inputting the first code which is issued by the first code issuing means of the vending machine;
a first transmitting means for sending the first code, which is input by the first input means, to the center device;
a receiving means for receiving the second code which is issued by the center device;
a second input means for inputting the third code which is issued by the third code issuing means of the vending machine; and
a second transmitting means for sending the third code, which is input by the second input means, to the center device; and
the center device comprises:
a verifying means for verifying the portable communication terminal according to communications with the portable communication terminal;
a settlement processing means for performing a settlement processing according to the first code sent by the first transmitting means of the portable communication terminal;
a second code issuing means for generating the second code by performing a prescribed processing of the first code and sending to the portable communication terminal; and
a settlement processing cancel means for canceling the settlement processing according to the third code sent from the second transmitting means of the portable communication terminal.

2. The cashless vending system according to claim 1, wherein:
the portable communication terminal has a display means for displaying the second code received by the receiving means;
the vending machine has an image reading means for reading the second code displayed on the display means; and
the second code obtaining means obtains the second code by reading the second code, which is displayed on the display means, by the image reading means.

3. The cashless vending system according to claim 1, wherein:
the vending machine has a display for displaying the first code which is issued by the first code issuing means;
the portable communication terminal has an imaging means which is built in or externally connected; and
the first input means inputs the first code by taking a picture of the first code, which is displayed on the display of the vending machine, by the imaging means.

4. The cashless vending system according to claim 1, wherein:
the vending machine has:
a change return lever, and
a detecting means for detecting an operation of the change return lever; and
the third code issuing means performs a prescribed processing of the first code to generate the third code and issues it when the operation of the change return lever is detected by the detecting means after the first code is issued by the first code issuing means.

5. The cashless vending system according to claim 1, wherein:
the vending machine has a display for displaying the third code which is issued by the third code issuing means;
the portable communication terminal has an imaging means which is built in or externally connected; and
the second input means inputs the third code by taking a picture of the third code, which is displayed on the display of the vending machine, by the imaging means.

6. A cashless vending control method, comprising:
issuing a first code about the sales of a commodity from a vending machine in response to a request by a user;
inputting the first code, which is issued from the vending machine, to a portable communication terminal carried by the user;
sending the first code, which is input to the portable communication terminal, from the portable communication terminal to a center device;
verifying the portable communication terminal by the center device according to communications with the portable communication terminal;
performing a settlement processing of the sales of commodity by the center device according to the first code sent from the portable communication terminal;
generating a second code about the commodity selling permission by performing a prescribed processing of the first code by the center device and sending it to the portable communication terminal;
displaying the second code, which is sent from the center device, on the display section of the portable communication terminal and presenting it to the vending machine;
reading the second code, which is displayed on the display section of the portable communication terminal and presented to the vending machine, by the image reading section of the vending machine;
controlling the sales of commodity in the vending machine according to the second code read by the image reading section;
issuing a third code about cancellation of the sales of the commodity from the vending machine in response to an operation by the user of the vending machine;
sending the third code to the center device when the third code is issued by the third code issuing means of the vending machine; and
canceling the settlement processing by the center device according to the third code sent from the portable communication terminal.

7. The cashless vending method according to claim 6, wherein:
the portable communication terminal displays the second code on the display section thereof; and
the vending machine obtains the second code by reading the second code displayed on the display section of the portable communication terminal by the image reading means.

8. The cashless vending method according to claim 6, wherein:
the vending machine has a display for displaying the first code; and
the portable communication terminal inputs the first code by taking a picture of the first code, which is displayed on the display of the vending machine, by an imaging means which is built in or externally connected to.

9. The cashless vending method according to claim 6, wherein the vending machine performs a prescribed processing of the first code to generate the third code and issues it when an operation of a change return lever of the vending machine is detected after the first code is issued.

10. The cashless vending method according to claim 6, wherein:
the vending machine has a display for displaying the third code; and
the portable communication terminal inputs the third code by taking a picture of the third code, which is displayed on the display of the vending machine, by an imaging means which is built in or externally connected to.

11. A vending machine from which a user can buy commodities by using a portable communication terminal possessed by the user, comprising:
a first code issuing means for issuing a first code about the sales of a commodity in response to a request by the user desiring the sales of the commodity;
a second code obtaining means for obtaining a second code about commodity selling permission, which is issued by a center device according to communications with the center device by the portable communication terminal, via the portable communication terminal;
a sales control means for controlling the sales of the commodity according to the second code obtained by the second code obtaining means; and
a third code issuing means for issuing a third code about cancellation of the sales of the commodity according to an operation by the user.

12. The vending machine according to claim 11, wherein:
the third code issuing means performs a prescribed processing of the first code to generate the third code and issues it when an operation of a change return lever is detected after the first code is issued by the first code issuing means.

13. A center device for settling sales made by a vending machine via a portable communication terminal possessed by a user, comprising:
a verifying means for verifying the portable communication terminal according to communications with the portable communication terminal;
a settlement processing means for performing a settlement processing according to a first code about the sales of a commodity sent from the portable communication terminal;
a second code issuing means for generating a second code about commodity selling permission by performing a prescribed processing of the first code and sending it to the portable communication terminal; and
a settlement processing cancel means for receiving a third code about the cancellation of the commodity sales issued by the vending machine according to an operation of the vending machine via the portable communication terminal and canceling the settlement processing according to the received third code.
